(19) United States
(12) Patent Application Publication
(10) Pub. No.: US 2026/0024422 A1
(43) Pub. Date: Jan. 22, 2026

(54) HAPTIC MEDIA CONTENT PROCESSING

(71) Applicant: TENCENT TECHNOLOGY (SHENZHEN) COMPANY LIMITED, Shenzhen (CN)

(72) Inventor: Ying HU, Shenzhen (CN)

(73) Assignee: TENCENT TECHNOLOGY (SHENZHEN) COMPANY LIMITED, Shenzhen (CN)

(21) Appl. No.: 19/340,516

(22) Filed: Sep. 25, 2025

Related U.S. Application Data
(63) Continuation of application No. PCT/CN2024/095458, filed on May 27, 2024.

(30) Foreign Application Priority Data
May 31, 2023 (CN) 202310644146.9

(51) Int. Cl. G08B 6/00

(52) U.S. Cl. CPC G08B 6/00

(57) ABSTRACT

In a haptic media content processing method, at least one haptic media signal is obtained. A haptic media interchange format is generated based on the at least one haptic media signal. The haptic media interchange format includes a haptic experience object, a haptic pattern object, a haptic channel object, a haptic event object, and a component element object. The haptic media interchange format is converted to obtain a haptic media binary bitstream. The haptic media binary bitstream is encapsulated into a haptic media file. The haptic media file is transmitted to a client.

### RELATED APPLICATIONS

The present application is a continuation of International Application No. PCT/CN2024/095458, filed on May 27, 2024, which claims priority to Chinese Patent Application No. 202310644146.9, filed on May 31, 2023. The entire disclosures of the prior applications are hereby incorporated by reference.

### FIELD OF THE TECHNOLOGY

This application relates to the field of multi-media data processing technologies, including a haptics media content processing method.

### BACKGROUND OF THE DISCLOSURE

Presentation of immersive media content usually involves various wearable devices or interactive devices. Therefore, in addition to related visual and auditory presentations, immersive media further incorporates a new form of presentation, namely, haptics presentation. With the popularization of wearable devices and interactive devices, the haptics presentation perceptible to a user when the user consumes media content is no longer limited to a basic vibrotactile form. Instead, it encompasses multi-dimensional haptics sensations that more closely approximates real-world haptics perception, such as vibration, pressure, velocity, acceleration, temperature, humidity, and olfactory. Therefore, how to uniformly express haptics media content becomes a challenge in haptics media consumption.

### SUMMARY

Aspects of this disclosure include a haptics media content processing method, a haptics media content decoding method, and a haptics media content decoding apparatus.

An aspect of this disclosure provides a haptic media content processing method. in the method, at least one haptic media signal is obtained. A haptic media interchange format is generated based on the at least one haptic media signal. The haptic media interchange format includes a haptic experience object, a haptic pattern object, a haptic channel object, a haptic event object, and a component element object. The haptic media interchange format is converted to obtain a haptic media binary bitstream. The haptic media binary bitstream is encapsulated into a haptic media file. The haptic media file is transmitted to a client.

An aspect of this disclosure provides a haptic media content decoding method. A haptic media file is received. The haptic media file is decapsulated to obtain a haptic media binary bitstream. The haptic media binary bitstream is converted to obtain a haptic media interchange format. The haptic media interchange format includes a haptic experience object, a haptic pattern object, a haptic channel object, a haptic event object, and a component element object. The haptic media interchange format is parsed to obtain at least one haptic media signal. The at least one haptic media signal is output to an output device.

An aspect of this disclosure provides a haptic media content decoding apparatus. The apparatus includes processing circuitry configured to receive a haptic media file. The processing circuitry is configured to decapsulate the haptic media file to obtain a haptic media binary bitstream. The processing circuitry is configured to convert the haptic media binary bitstream to obtain a haptic media interchange format. The haptic media interchange format includes a haptic experience object, a haptic pattern object, a haptic channel object, a haptic event object, and a component element object. The processing circuitry is configured to parse the haptic media interchange format to obtain at least one haptic media signal. The processing circuitry is configured to output the at least one haptic media signal to an output device.

An aspect of this disclosure provides a haptics media content processing method, which includes: acquiring at least one haptics media signal; generating a haptics media interchange format according to the at least one haptics media signal, the haptics media interchange format including at least one data object of a haptics experience object, an avatar information object, a device information object, a haptics pattern object, a haptics channel object, a haptics event object, and a component object; converting the haptics media interchange format, to obtain a haptics media binary bitstream; and encapsulating the haptics media binary bitstream into a haptics media file, and transmitting the haptics media file to a client.

An aspect of this disclosure further provides a haptics media content processing apparatus, which includes: a signal acquisition module, configured to acquire at least one haptics media signal; an interchange format generation module, configured to generate a haptics media interchange format according to the at least one haptics media signal, the haptics media interchange format including at least one data object of a haptics experience object, an avatar information object, a device information object, a haptics pattern object, a haptics channel object, a haptics event object, and a component object; an interchange format conversion module, configured to convert the haptics media interchange format, to obtain a haptics media binary bitstream; and an encapsulation and transmission module, configured to encapsulate the haptics media binary bitstream into a haptics media file, and transmit the haptics media file to a client.

An aspect of this disclosure further provides a haptics media content processing method, which includes: acquiring a haptics media file; or acquiring at least one file segment generated based on the haptics media file, and parsing the at least one file segment, to obtain the haptics media file; decapsulating the haptics media file, to obtain a haptics media binary bitstream; performing format inverse conversion on the haptics media binary bitstream to obtain a haptics media interchange format, the haptics media interchange format including at least one data object of a haptics experience object, an avatar information object, a device information object, a haptics pattern object, a haptics channel object, a haptics event object, and a component object; parsing the haptics media interchange format, to obtain at least one haptics media signal; and rendering and presenting the at least one haptics media signal.

An aspect of this disclosure further provides a haptics media content processing apparatus, which includes: a first module, configured to acquire a haptics media file; or acquire at least one file segment generated based on the haptics media file, and parse the at least one file segment, to obtain the haptics media file; a second module, configured to decapsulate the haptics media file, to obtain a haptics media binary bitstream; a third module, configured to perform format inverse conversion on the haptics media binary bitstream to obtain a haptics media interchange format, the haptics media interchange format including at least one data object of a haptics experience object, an avatar information object, a device information object, a haptics pattern object, a haptics channel object, a haptics event object, and a component object; a fourth module, configured to parse the haptics media interchange format, to obtain at least one haptics media signal; and a fifth module, configured to render and present the at least one haptics media signal.

An aspect of this disclosure further provides a haptics media content processing device, which includes: one or more processors; and a memory, configured to store one or more programs, the one or more processors executing the one or more programs, to cause the haptics media content processing device to implement the operations of the haptics media content processing method described above.

An aspect of this disclosure further provides a computer-readable storage medium, such as a non-transitory computer-readable storage medium, which has computer-readable instructions stored therein, the computer program, when executed by a processor, implementing the haptics media content processing method.

An aspect of this disclosure further provides a computer program product, which includes a computer program, a processor executing the computer program to implement the operations of the haptics media content processing method described above.

An aspect of this disclosure further provides a haptics media file storing method, which includes: storing a haptics media file in a non-volatile computer-readable storage medium, the haptics media file being generated according to the foregoing method or being decoded based on the following method.

An aspect of this disclosure provides a universal representation manner of haptics media content. For example, at least one data object is included in a haptics media interchange format, to correspondingly represent different types of haptics media signals. In addition, conversion from a haptics media interchange format into a haptics media binary bitstream is supported, whereby uniform expression of the haptics media content is achieved. Furthermore, the haptics media binary bitstream obtained through conversion is encapsulated into a haptics media file, and the haptics media file is transmitted to a client, whereby streaming transmission of the haptics media content is achieved.

The foregoing general descriptions and the following detailed descriptions are merely for illustration and explanation purposes and are not intended to limit this disclosure.

### BRIEF DESCRIPTION OF THE DRAWINGS

FIG. 1 is a diagram of a data structure association between data objects in a haptics media interchange format according to an aspect of this disclosure.

FIG. 2 is a flowchart of a haptics media content processing method according to an aspect of this disclosure.

FIG. 3 is a block diagram of a haptics media content processing apparatus according to an aspect of this disclosure.

FIG. 4 is a schematic structural diagram of a computer system adapted to implement a haptics media content processing device according to an aspect of this disclosure.

### DETAILED DESCRIPTION

Example aspects are described in further detail herein, and examples of the aspects are shown in the accompanying drawings. When the following description involves the accompanying drawings, unless otherwise indicated, the same numerals in different accompanying drawings represent the same or similar elements. Implementations described in the following aspects do not represent all implementations that are consistent with this disclosure. On the contrary, the implementations are merely examples of an apparatus and a method consistent with some aspects of this disclosure. Further, the descriptions of the terms are provided as examples only and are not intended to limit the scope of the disclosure.

The block diagrams shown in the accompanying drawings are merely functional entities and do not necessarily correspond to physically independent entities. That is, the functional entities may be implemented in the form of software, or in one or more hardware modules or integrated circuits, or in different networks and/or processor apparatuses and/or microcontroller apparatuses.

The flowcharts shown in the accompanying drawings are merely example descriptions, do not need to include all content and operations/steps, and do not need to be performed in the described orders either. For example, some operations/procedures may be further divided, while some operations/procedures may be combined or partially combined. Therefore, an actual execution order may change according to an actual case.

“Plurality of” mentioned in this disclosure means two or more. “And/or” describes an association relationship between associated objects, and indicates that three relationships may exist. For example, A and/or B may indicate three cases: only A exists, both A and B exist, and only B exists. The mark “/” indicates an “or” relationship between the associated objects.

In the description, claims, and drawings of this disclosure, the terms “first”, “second”, “third”, “fourth” and the like are intended to distinguish between different objects but do not indicate a particular order. The terms “include”, “have”, and any variant thereof are intended to cover a non-exclusive inclusion. For example, a process, method, system, product, or device that includes a series of operations or units is not limited to the listed operations or units; and instead, may further include an operation or unit that is not listed, or may further include another operation or unit that is intrinsic to the process, method, product, or device.

In addition, immersive media may be referred to as immersion or immersed media. In a broad sense, media that creates a sense of presence through audio/video technology is referred to as the immersive media. For example, a telephone allows individuals to communicate in a manner that resembles in-person conversation. For another example, when watching a movie on television, a viewer feels as if he/she is on the set of the movie even though he/she is physically at home. Presentation of immersive media content usually involves various wearable devices or interactive devices. Therefore, in addition to related visual and auditory presentations, immersive media further incorporates a new form of presentation, namely, haptics presentation. Haptics is the sensory experience that a human body obtains through touch, such as vibration, pressure, temperature, speed, and electrotactile.

Haptics presentation is implemented by using a haptics presentation mechanism combining hardware and software, which allows a user to receive information via a body part of the user, to obtain an immersed bodily sensation, and transfers key information about a system in use. For example, a mobile phone vibrates to remind its owner that a piece of information is received. Such vibration is a type of haptics presentation. In actual application, the haptics presentation may enhance the auditory and visual presentations, to improve user experience.

Currently, haptics information presentation has been widely applied, and is usually classified into three categories: a vibrotactile presentation, a kinematic haptics presentation, and an electrotactile presentation. The vibrotactile presentation refers to direct presentation of haptics in the form of vibration. For example, vibration at a specific frequency and intensity is simulated by vibration of a motor on a terminal device. For example, in a shooting game, a specific effect during shooting is simulated by vibration. The kinematic haptics presentation refers to presentation of haptics by simulating a movement state, such as weight or pressure, of an object. For example, in a driving video game, when a vehicle is moved at a relatively high speed or a relatively heavy vehicle is operated, a steering wheel may resist turning. This feedback directly affects muscles of a game player, and the game player needs to apply more force to obtain a needed response from the steering wheel. The electrotactile presentation refers to presentation of haptics by simulating feedback information of a particular texture through electrical stimulation. That is, the electrohaptics presentation uses an electrical impulse to provide haptics stimulation to nerve endings on the skin of a user, and may, for example, create a highly realistic experience for a user wearing a suit or a glove provided with an electrotactile technology.

It can be seen that, in current haptics presentation application in the industry, from a device vibrotactile presentation applied daily to diversified haptics presentations in subdivided fields, the haptics presentation itself has been a presentation manner that users are accustomed to. With the popularization and development of wearable devices and interactive devices, the haptics presentation perceptible to a user when the user consumes media content is no longer limited to a basic vibrotactile form. Instead, it encompasses multi-dimensional haptics sensations that more closely approximates real-world haptics perception, such as vibration, pressure, velocity, acceleration, temperature, humidity, and olfactory.

To efficiently and uniformly express haptics media content, and improve user consumption experience of haptics media, aspects of this disclosure provide a haptics media content processing method, apparatus, and device, a computer-readable storage medium, and a computer program product.

Before the aspects of this disclosure are described in further detail, a universal representation manner of haptics media content proposed in this disclosure is explained.

The universal representation manner of haptics media content proposed in this disclosure mainly includes two parts. A first part is generation of a haptics media interchange format based on haptics media content, and a second part is conversion from the haptics media interchange format into a haptics media binary bitstream. The two parts are described in further detail below.

First, the haptics media interchange format mentioned in this disclosure is configured for representing a haptics experience, and corresponds to at least one haptics media signal. The haptics media signal may be understood as a signal that is configured for representing a haptics experience in a specific modality and that is rendered and presented on a specific device.

To facilitate processing of the haptics media signal, the haptics media interchange format defined in this disclosure is A JavaScript Object Notation (JSON) format, but it does not mean that the haptics media interchange format is only limited to the JSON format. JSON is also referred to as an “object brief”, and is a lightweight data interchange format. It uses a text format independent of a programming language to store and represent data. A simple and clear hierarchical structure makes JSON an ideal data interchange language, easy for humans to read and write, easy for machines to parse and generate, and effectively improves network transmission efficiency.

Data structures included in the haptics media interchange format provided in this disclosure are shown in Table 1.

TABLE 1

| Data object name | Description | Type |
|---|---|---|
| AVS_haptics | Haptics experience. One haptics experience | JSON |
| | corresponds to one JSON interchange format | object |
| | file, which includes one or more haptics | |
| | signals | |
| AVS_haptics_avatar | Indicate avatar information related to | JSON |
| | rendering of a haptics signal | object |
| AVS_haptics_device | Indicate device information related to | JSON |
| | rendering of a haptics signal | object |
| AVS_haptics_pattern | Haptics pattern. One haptics pattern is a set of | JSON |
| | specific types of haptics signals, and types of | object |
| | the haptics signals include vibration, | |
| | temperature, and the like. | |
| AVS_haptics_channel | Haptics channel. One haptics pattern may | JSON |
| | include one or more haptics channels, and one | object |
| | haptics channel includes one or more haptics | |
| | events | |
| AVS_haptics_event | Indicate a single haptics event | JSON |
| | | object |
| AVS_haptics_event_component | Component forming a single haptics event | JSON |
| | | object |

In addition, in this disclosure, AVS_haptics in Table 1 is referred to as a haptics experience object, AVS_haptics_avatar is referred to as an avatar information object, AVS_haptics_device is referred to as a device information object, AVS_haptics_pattern is referred to as a haptics pattern object, AVS_haptics_channel is referred to as a haptics channel object, AVS_haptics_event is referred to as a haptics event object, AVS_haptics_event_component is referred to as a component object, and these data objects form basic data formats of the haptics media interchange format. For descriptions of the data objects, refer to the descriptions in Table 1. Details are not described herein again.

In addition, a haptics media interchange format generated in an actual application scenario may include only at least one of the data objects shown in Table 1. For example, if one haptics experience does not include avatar information or device information, a generated haptics media interchange format does not include a corresponding avatar object or a corresponding device information object.

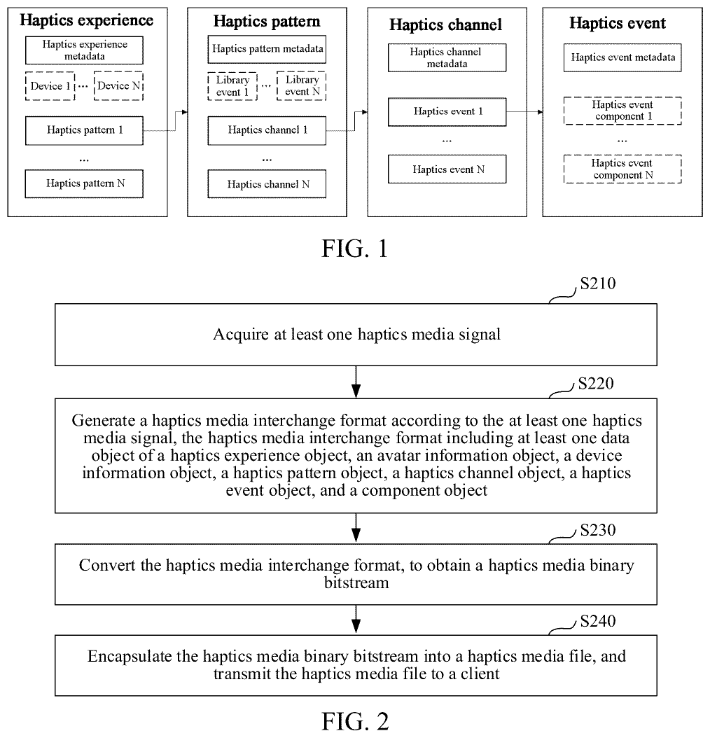

FIG. 1 is a diagram of a data structure association between data objects in a haptics media interchange format according to this disclosure. It can be seen that a layer association exists between the haptics experience object, the haptics pattern object, the haptics channel object, and the haptics event object, and layers thereof are in descending order. The haptics experience object is a highest-layer element included in the haptics media interchange format, indicates a haptics experience, and may also be understood as an information entry of the haptics experience. One haptics experience correspondingly includes haptics experience metadata and at least one haptics pattern, and may include related data of at least one specific device configured to present the haptics experience. One haptics pattern correspondingly includes haptics pattern metadata and at least one haptics channel, and may include related data of a library event. The library event is a repeated haptics event in one haptics experience, and defining the repeated haptics event as a library event may make a generated haptics media interchange format simpler. One haptics channel correspondingly includes haptics channel metadata and at least one haptics event. One haptics event correspondingly includes haptics event metadata and at least one haptics event component.

The following describes attributes included in the data objects that are included in the haptics media interchange format.

Definitions of attributes included in the haptics experience object AVS_haptics are shown in Table 2.

TABLE 2

| | | Default | | |
|---|---|---|---|---|
| Attribute | Data type | value | Description | Required |
| version | string | None | Indicate information | Yes |
| | | | about a version of a | |
| | | | specification followed | |
| | | | by haptics experience | |
| creation_date | string | None | Indicate creation time | Yes |
| | | | of haptics experience | |
| description | string | None | Description | Yes |
| | | | information of a | |
| | | | haptics experience, | |
| | | | customized by a user | |
| event_layer_flag | bool | None | Indicate whether a | No |
| | | | haptics event | |
| | | | corresponding to a | |
| | | | current experience is | |
| | | | classified into a layer | |
| avatar | array <AVS_{—} | None | Avatar element array, | No |
| | haptics_avatar> | | indicating one or more | |
| | | | pieces of avatar | |
| | | | information related to | |
| | | | the current haptics | |
| | | | experience | |
| device | array <AVS_{—} | None | Device element array, | No |
| | haptics_device> | | indicating one or more | |
| | | | pieces of device | |
| | | | information related to | |
| | | | the current haptics | |
| | | | experience | |
| pattern | array <AVS_{—} | None | Pattern element array, | Yes |
| | haptics_pattern> | | indicating one or more | |
| | | | haptics patterns | |
| | | | included in the current | |
| | | | haptics experience | |

In this disclosure, version in Table 2 is referred to as a version attribute, creation_date is referred to as a creation time attribute, description is referred to as a description information attribute, event_layer_flag is referred to as an attribute indicating whether a haptics event is classified into a layer, avatar is referred to as an attribute indicating avatar information related to a current haptics experience, device is referred to as an attribute indicating device information related to the current haptics experience, and pattern is referred to as an attribute indicating a haptics pattern related to the current haptics experience.

In addition, the item “required” mentioned in Table 2 indicates that a corresponding attribute may not exist in the haptics experience object in an actual application scenario. For example, as still described above, if in an actual application scenario, the haptics experience does not include avatar information or device information, avatar or device attributes will not exist in the haptics experience object.

In addition, event_layer_flag needs to be included in one data object of the haptics experience object, the haptics attribute object, and the haptics channel object, and is configured for indicating that layer classification of a haptics event is limited to only an inner portion of a corresponding data object. For example, when the haptics attribute object includes event_layer_flag, it indicates that values of haptics events under different haptics attributes cannot be compared with each other.

Definitions of attributes included in the avatar information object AVS_haptics_avatar are shown in Table 3.

TABLE 3

| | | Default | | |
|---|---|---|---|---|
| Attribute | Data type | value | Description | Required |
| id | integer | None | Identifier indicating an avatar | Yes |
| avatar_model_type | integer | None | Indicate a type of an avatar model, | Yes |
| | | | that is, define a specification | |
| | | | followed by the avatar model | |
| avatar_model_uri | string | None | Indicate a Uniform Resource | No |
| | | | Identifier (URI) address of an | |
| | | | avatar model file | |

In this disclosure, id in Table 3 is referred to as an attribute indicating an identifier of an avatar, avatar_model_type is referred to as an attribute indicating a type of an avatar model, and avatar_model_uri is referred to as an attribute indicating a URI address of an avatar model file. The avatar mentioned in this disclosure may be a receiver of a haptics experience, who is usually a user of a wearable device or an interactive device. The avatar model is an abstract model configured for representing a body part of an avatar, and a type of the avatar model defines a specification followed by the avatar model.

In addition, avatar_model_uri is not a required attribute in the avatar information object. In this disclosure, the avatar model file is not limited to being stored on an Internet device such as a resource storage server, and it may be, for example, locally stored on a current device. When the avatar model file is stored on an Internet device, an avatar model file needs to be acquired and used according to a corresponding URI.

Definitions of attributes included in the device information object AVS_haptics_device are shown in Table 4.

TABLE 4

| | Data | | | |
|---|---|---|---|---|
| Attribute | type | Default value | Description | Required |
| id | integer | None | Indicate an identifier of a device | Yes |
| device_name | string | None | Indicate a name of the device | Yes |
| refer_avatar | integer | None | Indicate an avatar corresponding to | No |
| | | | a current device, and a value of the | |
| | | | field needs to correspond to a | |
| | | | corresponding avatar identifier | |
| refer_avatar_parts | string | None | Indicate specific information about | No |
| | | | the avatar corresponding to the | |
| | | | current device | |
| body_parts | integer | None | Indicate a body part of the avatar | No |
| | | | corresponding to the current device | |

In this disclosure, id in Table 4 is referred to as a device identifier attribute, device_name is referred to as a device name attribute, refer_avatar is referred to as an attribute indicating an avatar corresponding to a current device, refer_avatar_parts is referred to as an attribute indicating specific information about the avatar corresponding to the current device, and body_parts is referred to as an attribute indicating a body part of the avatar corresponding to the current device.

Example definitions of body parts of an avatar are shown in Table 5.

TABLE 5

| Serial No. | Meaning | Binary field | Decimal field |
|---|---|---|---|
| 0 | Undefined | 00000000000000000000000000000000 | 0 |
| 1 | Front of the head | 00000000000000000000000000000001 | 1 |
| 2 | Back of the head | 00000000000000000000000000000010 | 2 |
| 3 | Right side of the head | 00000000000000000000000000000100 | 4 |
| 4 | Left side of the head | 00000000000000000000000000001000 | 8 |
| 5 | Upper right chest | 00000000000000000000000000010000 | 16 |
| 6 | Upper left chest | 00000000000000000000000000100000 | 32 |

Definitions of attributes in the haptics pattern object AVS_haptics_pattern are shown in Table 6.

TABLE 6

| | | Default | | |
|---|---|---|---|---|
| Attribute | Data type | value | Description | Required |
| id | integer | None | Indicate an identifier | Yes |
| | | | of a haptics pattern | |
| pattern_type | enum<string> | None | Indicate a type of | Yes |
| | | | pattern, and possible | |
| | | | values are as follows: | |
| | | | Vibrotactile | |
| | | | presentation | |
| | | | Pressure | |
| | | | Acceleration | |
| | | | Speed | |
| | | | Temperature | |
| | | | Electrotactile | |
| refer_devices | array <integer> | None | Indicate a device | No |
| | | | corresponding to a | |
| | | | current pattern, and a | |
| | | | value of the field | |
| | | | corresponds to a | |
| | | | device identifier | |
| | | | defined in device | |
| | | | information | |
| refer_avatars | array <integer> | None | Indicate an avatar | No |
| | | | corresponding to the | |
| | | | current pattern, and a | |
| | | | value of the field | |
| | | | corresponds to an | |
| | | | avatar identifier | |
| | | | defined in avatar | |
| | | | information | |
| event_semantics_flag | bool | None | Indicate whether | Yes |
| | | | semantics of a haptics | |
| | | | event corresponding | |
| | | | to the current pattern | |
| | | | exists | |
| event_semantics_type | integer | None | Indicate a | Mandatory-if- |
| | | | specification | applicable |
| | | | followed by the | |
| | | | semantics of the | |
| | | | haptics event | |
| event_layer_flag | bool | None | Indicate whether the | No |
| | | | haptics event | |
| | | | corresponding to the | |
| | | | current pattern is | |
| | | | classified into a layer | |
| library_events | array <AVS_{—} | None | Indicate a library | No |
| | haptics_event> | | haptics event | |
| | | | included in the | |
| | | | current pattern | |
| channels | array <AVS_{—} | None | Indicate a haptics | Yes |
| | haptics_channel> | | channel included in | |
| | | | the current pattern | |

In this disclosure, id in Table 6 is referred to as a pattern identifier attribute, pattern_type is referred to as a pattern type attribute, refer_devices is referred to as an attribute of a device corresponding to a current pattern, refer_avatar is referred to as an attribute of an avatar corresponding to the current pattern, event_semantics_flag is referred to as an attribute indicating whether semantics of a haptics event corresponding to the current pattern exist, event_semantics_type is referred to as an attribute indicating a specification followed by the semantics of the haptics event, event_layer_flag is referred to as an attribute indicating whether the haptics event is classified into a layer, library_events is referred to as an attribute indicating a library haptics event included in the current pattern, and channels is referred to as an attribute indicating a haptics channel included in the current pattern.

In addition, event_semantics_type is a mandatory-if-applicable attribute. When a value of the attribute event_semantics_flag is true, it indicates that the semantics of the haptics event corresponding to the current pattern exists. Therefore, the attribute event_semantics_type needs to exist.

In addition, as an example implementation, when a value of event_semantics_type is 0, it may indicate that the semantics of the haptics event conforms to a specification defined by a standard; when the value of event_semantics_type is 1, it may indicate that the semantics of the haptics event conforms to a specification defined by an external standard; and when the value of event_semantics_type is 2, it may indicate that the semantics of the haptics event is customized by a user. The standard mentioned herein refers to a format standard of the haptics media interchange format mentioned in this disclosure.

Definitions of attributes included in the haptics channel object AVS_haptics_channel are shown in Table 7.

TABLE 7

| | | Default | | |
|---|---|---|---|---|
| Attribute | Data type | value | Description | Required |
| id | integer | None | Indicate an identifier of | Yes |
| | | | a channel | |
| description | string | None | Indicate a description | Yes |
| | | | of the channel, | |
| | | | customized by a user | |
| refer_devices | array <integer> | None | Indicate a device | No |
| | | | corresponding to a | |
| | | | current channel, and a | |
| | | | value of the field needs | |
| | | | to correspond to a | |
| | | | corresponding device | |
| | | | identifier | |
| refer_avatars | array <integer> | None | Indicate an avatar | No |
| | | | corresponding to the | |
| | | | current channel, and a | |
| | | | value of the field needs | |
| | | | to correspond to a | |
| | | | corresponding avatar | |
| | | | identifier | |
| gain | number | None | Indicate a gain of the | Yes |
| | | | current channel, the | |
| | | | gain is applied to all | |
| | | | events included in the | |
| | | | current channel | |
| channel_alternative_flag | bool | false | Indicate whether the | Yes |
| | | | current channel (or a | |
| | | | channel group) is in an | |
| | | | alternative relationship | |
| | | | with another channel | |
| | | | (or a channel group) | |
| alternative_group_id | integer | None | Indicate an identifier of | Mandatory-if- |
| | | | an alternative channel | applicable |
| | | | group to which the | |
| | | | current channel (or the | |
| | | | channel group) | |
| | | | belongs, and only one | |
| | | | channel (or a channel | |
| | | | group) in one | |
| | | | alternative channel | |
| | | | group needs to be | |
| | | | presented. The field is a | |
| | | | mandatory field when a | |
| | | | value of | |
| | | | channel_alternative_flag | |
| | | | is true | |
| channel_group_flag | bool | false | Indicate whether the | Yes |
| | | | current channel belongs | |
| | | | to a particular channel | |
| | | | group | |
| channel_group_id | integer | None | Indicate an identifier of | Mandatory-if- |
| | | | a channel group to | applicable |
| | | | which the current | |
| | | | channel belongs, and | |
| | | | weighted mixing is | |
| | | | performed on all | |
| | | | channels in the channel | |
| | | | group to obtain a final | |
| | | | signal that needs to be | |
| | | | rendered, channels | |
| | | | belonging to a same | |
| | | | channel group need to | |
| | | | have a same channel | |
| | | | group identifier, and | |
| | | | channels belonging to | |
| | | | different channel | |
| | | | groups need to have | |
| | | | different channel group | |
| | | | identifiers, and the field | |
| | | | is a mandatory field | |
| | | | when a value of | |
| | | | channel_group_flag is | |
| | | | true | |
| mixing_weight | number | None | The field is a | Mandatory-if- |
| | | | mandatory field if the | applicable |
| | | | current channel belongs | |
| | | | to a particular channel | |
| | | | group, and indicates a | |
| | | | weight of the current | |
| | | | channel in a | |
| | | | corresponding channel | |
| | | | group | |
| event_layer_flag | bool | None | Indicate whether a | No |
| | | | haptics event | |
| | | | corresponding to the | |
| | | | current channel is | |
| | | | classified into a layer | |
| priority | integer | None | Indicate a priority of | No |
| | | | the current channel, and | |
| | | | a smaller value of the | |
| | | | field indicates a higher | |
| | | | priority of the channel | |
| events | array <AVS_{—} | None | Indicate a haptics event | Yes |
| | haptics_event> | | included in the current | |
| | | | channel | |

In this disclosure, id in Table 7 is referred to as a channel identifier attribute, description is referred to as a channel description attribute, refer_devices is referred to as an attribute indicating a device corresponding to a current channel, refer_avatar is referred to as an attribute indicating an avatar corresponding to the current channel, gain is referred to as a channel gain attribute, channel_alternative_flag is referred to as an attribute indicating whether the current channel is in an alternative relationship with another haptics channel, alternative_group_id is referred to as an attribute indicating an identifier of an alternative channel group to which the current channel belongs, channel_group_flag is referred to as an attribute indicating whether the current channel belongs to a particular channel group, channel_group_id is referred to as an attribute indicating an identifier of a channel group to which the current channel belongs, mixing_weight is referred to as an attribute indicating a weight of the current channel in the corresponding channel group, event_layer_flag is referred to as an attribute indicating whether a haptics event is classified into a layer, priority is referred to as an attribute indicating a priority of the current channel, and events is referred to as an attribute indicating a haptics event included in the current channel.

In addition, when the alternative channel group to which the current channel belongs exists, for available refer_devices, refer_avatar, and priority, only a channel with a minimum identifier value in the channel group is indicated, and is not repeatedly indicated in metadata of another channel in the channel group.

In addition, the default values of channel_alternative_flag and channel_group_flag are 0, which indicates that by default, the current channel is not in the alternative relationship with another channel, and the current channel does not belong to a particular channel group. In an actual application scenario, values of the attributes need to be modified according to an actual requirement. Furthermore, alternative_group_id exists only when a value of channel_alternative_flag is true, and channel_group_id and mixing_weight exist only when a value of channel_group_flag is true. priority is an unnecessary attribute in the haptics channel object. In an actual application scenario, different haptics channels may not be classified into different priorities. Definitions of attributes included in the haptics event object AVS_haptics_event are shown in Table 8.

TABLE 8

| | | Default | | |
|---|---|---|---|---|
| Attribute | Data type | value | Description | Required |
| id | integer | None | Indicate an identifier | Yes |
| | | | of a haptics event | |
| effect_semantic | string | None | Indicate semantics of | Mandatory-if- |
| | | | the haptics event. The | applicable |
| | | | field is a mandatory | |
| | | | field when a value of | |
| | | | a field | |
| | | | event_semantics_flag | |
| | | | in a corresponding | |
| | | | pattern is true | |
| event_layer | integer | 0 | Indicate a layer of the | Mandatory-if- |
| | | | haptics event, the | applicable |
| | | | field is a mandatory | |
| | | | field when a value of | |
| | | | a field | |
| | | | event_layer_flag in a | |
| | | | corresponding pattern | |
| | | | or channel is true. | |
| | | | When the haptics | |
| | | | event is presented, a | |
| | | | low-layer haptics | |
| | | | event is preferentially | |
| | | | presented, and if no | |
| | | | layer field exists in | |
| | | | the haptics event, the | |
| | | | layer of the haptics | |
| | | | event is 0 by default. | |
| event_type | enum<string> | None | Indicate a type of | Yes |
| | | | event, and possible | |
| | | | values are as follows: | |
| | | | Instantaneous event | |
| | | | Duration | |
| | | | Reference event | |
| refer_library_event | integer | None | When the type of the | Mandatory-if- |
| | | | event is a reference | applicable |
| | | | event, the field is a | |
| | | | mandatory field, and | |
| | | | indicates an identifier | |
| | | | of a library haptics | |
| | | | event corresponding | |
| | | | to the reference event | |
| relative_time | integer | None | Indicate a time offset | No |
| | | | of the current event | |
| duration | integer | None | Indicate duration of | Mandatory-if- |
| | | | the current event, and | applicable |
| | | | when a type of the | |
| | | | current event is a | |
| | | | continuous event, the | |
| | | | field is a mandatory | |
| | | | field | |
| amplitude | integer | None | Indicate a signal | Yes |
| | | | maximum amplitude | |
| | | | value of the current | |
| | | | event | |
| base_frequency | integer | None | Indicate a signal base | Yes |
| | | | frequency of the | |
| | | | current event | |
| event_components | array <AVS_haptics_{—} | None | Indicate a component | No |
| | event_component> | | forming the current | |
| | | | event, and may be a | |
| | | | time domain | |
| | | | component or a | |
| | | | frequency domain | |
| | | | component. | |

In this disclosure, id in Table 8 is referred to as an event identifier attribute, effect_semantic is referred to as an event semantics attribute, event_layer is referred to as an event layer attribute, event type is referred to as an event type attribute, refer_library_event is referred to as an attribute indicating an identifier of a corresponding library haptics event when a type of an event is a reference event, relative_time is referred to as an attribute indicating a time offset of the current event, duration is referred to as an attribute indicating duration of the current event, amplitude is referred to as an attribute indicating a signal maximum amplitude value of the current event, base_frequency is referred to as an attribute indicating a signal base frequency of the current event, and event_components is referred to as an attribute indicating a component forming the current event.

In addition, when a value of an attribute event_semantics_flag of a haptics pattern corresponding to a haptics event is true, effect_semantic is a mandatory attribute in the haptics event object. When a value of an attribute event_layer_flag in a haptics experience, a haptics pattern, or a haptics channel corresponding to a haptics event is true, event_layer is a mandatory attribute in the haptics event object. When the haptics event is presented, a low-layer haptics event is preferentially presented. If no layer field exists in the haptics event, the layer of the haptics event is 0 by default.

Definitions of attributes included in the component object AVS_haptics_event_component are shown in Table 9.

TABLE 9

| | Data | Default | | |
|---|---|---|---|---|
| Attribute | type | value | Description | Required |
| refer_event_id | integer | None | Indicate an identifier of a haptics event to | Yes |
| | | | which a current component belongs | |
| relative_time | integer | None | Indicate a time offset of the current | No |
| | | | component relative to the haptics event | |
| relative_amplitude | number | None | Indicate an amplitude value ratio of the | No |
| | | | current component to the haptics event, | |
| | | | which ranges from 0 to 1 | |
| relative_frequency | integer | None | Indicate a frequency offset of the current | No |
| | | | component relative to the haptics event | |

In this disclosure, refer_event_id in Table 9 is referred to as an attribute indicating an identifier of a haptics event to which a current component belongs, relative_time is referred to as an attribute indicating a time offset of the current component relative to the haptics event, relative_amplitude is referred to as an attribute indicating an amplitude value ratio of the current component to the haptics event, and relative_frequency is referred to as an attribute indicating a frequency offset of the current component relative to the haptics event.

It can be seen from Table 1 to Table 9 and FIG. 1 that the haptics media interchange format provided in this disclosure may be summarized to include the following information, to efficiently and uniformly express haptics media content:
1) basic metadata, presentation device information, and presentation position information of the haptics media;
2) metadata information configured for organizing the haptics media content into different layers according to principles such as a signal type and a signal rendering position, and indicating each layer; and
3) metadata information configured for defining a basic layer of a haptics media signal according to a classification manner such as time, space, or frequency, and indicating the basic layer.

This disclosure further proposes a method for converting the foregoing haptics media interchange format into a haptics media binary bitstream, to facilitate subsequent file encapsulation and transmission. Data structures of the haptics media interchange format and the haptics media binary bitstream may correspond to each other.

The haptics media binary bitstream includes a binary header and a binary load. The binary header includes metadata related to a haptics experience, a haptics pattern, and a haptics channel, and the binary load includes metadata related to a haptics event.

Conversion of a haptics media interchange format into a haptics media binary bitstream refers to performing binary bit format conversion on each attribute in each data object included in the haptics media interchange format according to a predefined attribute conversion rule.

Syntax for performing binary bit format conversion on a haptics experience object is shown in Table 10.

TABLE 10

| Syntax | Number of bits | Remark |
|---|---|---|
| AVS_haptics( ) | | |
| { | | |
| versionStringSize | 8 | uimsbf |
| version; | versionStringSize*8 | string |
| dateStringSize | 8 | uimsbf |
| creation_date; | dateStringSize*8 | string |
| descriptionStringSize | 8 | uimsbf |
| description; | descriptionStringSize*8 | string |
| eventLayerFlag | 1 | bool |
| avatarCount; | 8 | uimsbf |
| for (i=0; i<avatarCount; i | | |
| ++) { | | |
| AVS_haptics_avatar( ); | | |
| } | 8 | uimsbf |
| deviceCount; | | |
| for (i=0; i<avatarCount; i ++) { | | |
| AVS_haptics_device( ); | | |
| } | | |
| patternCount; | 8 | uimsbf |
| for (i=0; i<patternCount; i ++) { | | |
| AVS_haptics_pattern( ); | | |
| } | | |
| } | | |

versionStringSize, dateStringSize, and descriptionStringSize respectively indicate a size of a corresponding character string, avatarCount, deviceCount, and patternCount respectively indicate a count of corresponding data structures, and the remaining fields and data structures correspond to the corresponding fields and data structures that are defined in the interchange format.

Syntax for performing binary bit format conversion on an avatar information object is shown in Table 11.

TABLE 11

| Syntax | Number of bits | Remark |
|---|---|---|
| AVS_haptics_avatar( ) | | |
| { | | |
| id | 8 | uimsbf |
| avatarModelType | 8 | uimsbf |
| avatarModelUriStringSize | 16 | uimsbf |
| avatarModelUri | avatarModelUriStringSize*8 | string |
| } | | |

avatarModelUriStringSize indicates a size of a corresponding character string, and the remaining fields and data structures correspond to the corresponding fields and data structures that are defined in the interchange format.

Syntax for performing binary bit format conversion on a device information object is shown in Table 12.

TABLE 12

| Syntax | Number of bits | Remark |
|---|---|---|
| AVS_haptics_device( ) | | |
| { | | |
| id | 8 | uimsbf |
| deviceNameStringSize | 16 | uimsbf |
| referAvatarFlag | 1 | bool |
| referAvatarPartsFlag | 1 | bool |
| bodyPartsFlag | 1 | bool |
| deviceName | deviceNameStringSize*8 | string |
| if (referAvatarFlag == 1) { | 8 | uimsbf |
| referAvatarId | | |
| } | | |
| if (referAvatarPartsFlag == 1) { | | |
| avatarPartsStringSize; | 16 | uimsbf |
| avatarParts | avatarPartsStringSize*8 | string |
| } | | |
| if (bodyPartsFlag == 1) { | | |
| bodyParts; | 32 | uimsbf |
| } | | |
| } | | |

referAvatarFlag, referAvatarPartsFlag and bodyPartsFlag respectively indicate whether to refer to avatar information, whether to refer to avatar body information, and whether to correspond to body part information, deviceNameString Size and avatarPartsStringSize respectively indicate a size of a character string of a device name and a size of a character string of avatar body information, and the remaining fields and data structures correspond to the corresponding fields and data structures that are defined in the interchange format.

Syntax for performing binary bit format conversion on a haptics pattern object is shown in Table 13.

TABLE 13

| Syntax | Number of bits | Remark |
|---|---|---|
| AVS_haptics_pattern( ) | | |
| { | | |
| id | 8 | uimsbf |
| patternType | 8 | uimsbf |
| referDeviceCount | 8 | uimsbf |
| referAvatarCount | 8 | uimsbf |
| libraryEventCount | 8 | uimsbf |
| channelCount | 8 | uimsbf |
| eventSemanticsFlag | 1 | bool |
| eventLayerFlag | 1 | bool |
| if (eventSemanticsFlag == 1) { | | |
| eventSemanticsType; | 8 | uimsbf |
| } | | |
| for (i=0; i<referDeviceCount; i ++) { | | |
| referDeviceId; | 8 | uimsbf |
| } | | |
| for (i=0; i<referAvatarCount; i ++) { | | |
| referAvatarId; | 8 | uimsbf |
| } | | |
| for (i=0; i<libraryEventCount; i ++) { | | |
| libraryEventId: | 16 | uimsbf |
| } | | |
| for (i=0; i<channelCount; i ++) { | | |
| AVS_haptics_channel( ): | | |
| } | | |
| } | | |

referDeviceCount, referAvatarCount, libraryEventCount, and channelCount respectively indicate a count of reference devices, a count of reference avatars, a count of library events, and a count of channels, libraryEventId indicates an identifier of a library event, and the remaining fields and data structures correspond to the corresponding fields and data structures that are defined in the interchange format.

patternType indicates a type of a pattern, whose value is shown in Table 14.

TABLE 14

| Value | Meaning |
|---|---|
| 0 | Other |
| 1 | Vibrotactile presentation |
| 2 | Pressure |
| 3 | Acceleration |
| 4 | Speed |
| 5 | Temperature |
| 6 | Electrotactile |
| 7-255 | Reserved |

Syntax for performing binary bit format conversion on a haptics channel object is shown in Table 15.

TABLE 15

| Syntax | Number of bits | Remark |
|---|---|---|
| AVS_haptics_channel( ) | | |
| { | | |
| id | 8 | uimsbf |
| descriptionStringSize | 8 | uimsbf |
| description | descriptionStringSize*8 | string |
| referDeviceCount | 8 | uimsbf |
| referAvatarCount | 8 | uimsbf |
| gain | 32 | float |
| alternativeFlag | 1 | bool |
| groupFlag | 1 | bool |
| priorityFlag | 1 | bool |
| eventLayerFlag | 1 | bool |
| eventCount | 8 | uimsbf |
| for (i=0; i<referDeviceCount; i ++) { | | |
| referDeviceId; | 8 | uimsbf |
| } | | |
| for (i=0; i<referAvatarCount; i ++) { | | |
| referAvatarId; | 8 | uimsbf |
| } | | |
| for (i=0; i<eventCount; i ++) { | | |
| eventId: | 16 | uimsbf |
| } | | |
| if (alternativeFlag == 1) { | | |
| alternativeId: | 16 | uimsbf |
| } | | |
| if (groupFlag == 1) { | | |
| groupId: | 16 | uimsbf |
| } | | |
| if (weightFlag == 1) { | | |
| mixWeight: | 32 | float |
| } | | |
| if (priorityFlag == 1) { | | |
| priority: | 8 | uimsbf |
| } | | |
| } | | |

descriptionStringSize indicates a size of a corresponding character string, referDeviceCount, referAvatarCount, and eventCount respectively indicate a count of reference devices, a count of reference avatars, and a count of events, alternativeFlag, groupFlag, weightFlag, priorityFlag respectively indicate whether a current channel belongs to an alternative channel group, whether the current channel belongs to a channel group, whether the current channel includes weight information, and whether the current channel includes priority information, eventId indicates an identifier of an event included in the current channel, and the remaining fields and data structures correspond to the corresponding fields and data structures that are defined in the interchange format.

Syntax for performing binary bit format conversion on a haptics event object is shown in Table 16.

TABLE 16

| Syntax | Number of bits | Remark |
|---|---|---|
| AVS_haptics_event( ) | | |
| } | | |
| eventStartCode | 32 | uimsbf |
| id | 16 | uimsbf |
| eventType | 8 | uimsbf |
| if (eventSemanticsFlag == 1) { | | uimsbf |
| eventSemanticsStringSize; | 16 | |
| eventSemantics | eventSemanticsStringSize*8 | string |
| } | | |
| if (eventLayerFlag == 1) { | | |
| eventLayer | 8 | uimsbf |
| } | | |
| referDeviceCount | 8 | uimsbf |
| referAvatarCount | 8 | uimsbf |
| libEventFlag | 1 | bool |
| if (eventType == 2) { | | |
| referLibEventId: | 16 | uimsbf |
| } | | |
| if (libEventFlag == 0) { | | |
| relativeTime: | 32 | uimsbf |
| } | | |
| if (eventType == 1) { | | |
| duration: | 32 | uimsbf |
| } | | |
| if (eventType! = 2) { | | |
| amplitude: | 16 | uimsbf |
| base_frequency | 32 | uimsbf |
| } | | |
| for (i=0; i<referDeviceCount; i ++) { | | |
| referDeviceId; | 8 | uimsbf |
| } | | |
| for (i=0; i<referAvatarCount; i ++) { | | |
| referAvatarId; | 8 | uimsbf |
| } | | |
| eventComponentCount | 16 | uimsbf |
| for (i=0; i<eventComponentCount; i ++) { | | |
| AVS_haptics_event_component( ): | | |
| } | | |
| } | | |

eventStartCode indicates a start code of an event. When a value of eventType is 0, it indicates an instantaneous event; when the value of eventType is 1, it indicates duration; and when the value of eventType is 2, it indicates reference time. For an instantaneous event, duration of the instantaneous event is a fixed value, and usually depends on a device. referDeviceCount, referAvatarCount, and eventComponentCount respectively indicate a count of reference devices, a count of reference avatars, and a count of event components. When a value of libEventFlag is 1, it indicates that a current event is a library event; and when the value of libEventFlag is 0, it indicates that the current event is not a library event. The library event does not have a time offset value. The remaining fields and data structures correspond to the corresponding fields and data structures that are defined in the interchange format. eventSemanticsStringSize indicates a size of a character string of semantics of a haptics event. eventSemantics indicates the semantics of the haptics event.

Syntax for performing binary bit format conversion on a component object is shown in Table 17.

TABLE 17

| Syntax | Number of bits | Remark |
|---|---|---|
| AVS_haptics_event_component( ) | | |
| { | | |
| referEventId | 16 | uimsbf |
| relativeAmplitudeFlag | 1 | bool |
| relativeTimeFlag | 1 | bool |
| relativeFrequencyFlag | 1 | bool |
| if (relativeAmplitudeFlag == 1) { | | |
| relativeAmplitude: | 32 | float |
| } | | |
| if (relativeTimeFlag == 0) { | | |
| relativeTime: | 32 | uimsbf |
| } | | |
| if (relativeFrequencyFlag == 1) { | | |
| relativeFrequency: | 32 | uimsbf |
| } | | |
| } | | |

It can be seen from Table 10 to Table 17 that in this disclosure, for the attribute conversion manner for converting the haptics media interchange format may be generalized as the following manner:
1) a string-type attribute, an integer-type attribute, an enumeration-type attribute, or a number-type attribute in each data object is converted into binary bitstream segments of several integer bytes, and a byte size corresponding to each binary bitstream segment may be a preset value;
2) a Boolean-type attribute is converted into a binary bitstream segment of several bits; and
3) a count of array elements included in an array-type attribute is statistically collected, and a corresponding attribute is converted into a binary bitstream segment based on the count of array elements.

Certainly, in an implementation, a byte size of the binary bitstream segment obtained by converting the attribute of each data type may be correspondingly adjusted. This is not limited to the byte size shown in Table 10 to Table 17 herein.

In addition, during conversion of the attributes in the haptics event object, when a value of eventSemanticsType in the haptics pattern object is 0, that is, when the semantics of the haptics event follow a current standard, the semantics of the haptics event may be defined in one of the following several manners:
1) the semantics of the haptics event is defined as a two-level semantic structure, and semantics of different layers are divided by using spaces or “/”, for example, “texture/rock” indicates that the haptics event simulates a texture of a stone;
2) the semantics of the haptics event is defined as a three-level semantic structure, and semantics of different layers are divided by using spaces or “/”, for example, “game/weapon/shotgun” indicates that the haptics event simulates a gunshot in a game; and
3) the semantics of the haptics event is defined as a multi-level semantic structure, and semantics of different layers are divided by using spaces.

Therefore, in an aspect, when binary bit format conversion is performed on the haptics event object, the definition of the foregoing hierarchical haptics semantic conversion manner may alternatively be shown in Table 18.

TABLE 18

| Syntax | Number of bits | Remark |
|---|---|---|
| if (eventSemanticsFlag == 1) { | 8 | |
| eventSemanticsLevelNum | | uimsbf |
| for (int i=0; | | |
| i<eventSemanticsLevelNum; i ++) { | 16 | uimsbf |
| semanticsLevelStringSize; | semanticsLevelStringSize*8 | string |
| eventSemantics[i] | | |
| } | | |
| } | | |
| } | | |

In an aspect, for semantics of a readable string-type haptics event, a conversion manner thereof may further be defined as a specific binary field, as shown in Table 19.

TABLE 19

| Syntax | Number of bits | Remark |
|---|---|---|
| if (eventSemanticsFlag == 1) { | | |
| eventSemanticsLevelNum | 8 | uimsbf |
| for (int i=0; | | |
| i<eventSemanticsLevelNum; i ++) { | 8 | uimsbf |
| semanticsLevelBitsNum[i] | semanticsLevelBitsNum[i] | uimsbf |
| eventSemantics[i] | | |
| } | | |
| } | | |
| } | | |

Two-level syntax is taken as an example:
eventSemanticsLevelNum=2;
semanticsLevelBitsNum[0]=4, eventSemantics[0]=0001, corresponding to a texture; and
semanticsLevelBitsNum[1]=4, eventSemantics[0]=0010, corresponding to a rock.

Based on the foregoing recorded universal haptics media content representation manner, the aspects of this disclosure provide a haptics media content processing method. The method is applied to a product related to haptics feedback, such as a server, a player, or an intermediate node of an immersive system. This is not limited herein.

As shown in FIG. 2, the method includes the following operations.

S210: Acquire at least one haptics media signal. For example, at least one haptic media signal is obtained.

S220: Generate a haptics media interchange format according to the at least one haptics media signal, the haptics media interchange format including at least one data object of a haptics experience object, an avatar information object, a device information object, a haptics pattern object, a haptics channel object, a haptics event object, and a component object. For example, a haptic media interchange format is generated based on the at least one haptic media signal. The haptic media interchange format includes a haptic experience object, a haptic pattern object, a haptic channel object, a haptic event object, and a component element object.

S230: Convert the haptics media interchange format, to obtain a haptics media binary bitstream. For example, the haptic media interchange format is converted to obtain a haptic media binary bitstream.

S240: Encapsulate the haptics media binary bitstream into a haptics media file, and transmit the haptics media file to a client. For example, the haptic media binary bitstream is encapsulated into a haptic media file. The haptic media file is transmitted to a client.

In addition, the haptics media information acquired in S210 may be, for example, created or collected according to an expected haptics media effect. A manner for generating the haptics media interchange format in S220 and a manner for converting to obtain the haptics media binary bitstream in S230 are both described in the foregoing recorded content. Details are not described herein again. Encapsulation of the haptics media binary bitstream into the haptics media file in S240 may be, for example, encapsulation based on an International Organization for Standardization Based Media File Format (ISOBMFF), or encapsulation based on another media file format. This is not limited herein. The encapsulated haptics media file may be streamed and transmitted to the client. For example, the haptics media file is transmitted to the client in its entirety. Alternatively, at least one file segment may be generated based on the haptics media file, and the at least one file segment is transmitted to the client. After receiving the file or the file segment, the client parses the file or the file segment, to obtain the haptics media file including the haptics signal. After decapsulation and decoding, the client obtains the haptics media signal and renders and presents the haptics media signal. Therefore, the haptics media content can be efficiently and uniformly expressed.

In addition, during streaming transmission, a server needs to transmit a signaling message describing a media resource to the client, and the client then requests a specific media resource according to the signaling message. Therefore, in this aspect, transmission of the haptics media file to the client may be performed after corresponding request signaling transmitted by the client is received.

The following describes examples of the data objects in the haptics media interchange format generated in S220. For definitions of attributes included in the data objects, refer to the foregoing descriptions. Details are not described herein again.

The haptics experience object includes at least one of a version attribute, a creation time attribute, a description information attribute, an attribute indicating a haptics pattern related to a current haptics experience, an attribute indicating avatar information related to the current haptics experience, an attribute indicating device information related to the current haptics experience, and an attribute indicating whether a haptics event is classified into a layer.

The avatar information object includes at least one of an attribute indicating an identifier of an avatar, an attribute indicating a type of an avatar model, and an attribute indicating a URI address of an avatar model file.

The device information object includes at least one of a device identifier attribute, a device name attribute, an attribute indicating an avatar corresponding to a current device, an attribute indicating specific information about the avatar corresponding to the current device, and an attribute indicating a body part of the avatar corresponding to the current device.

The haptics pattern object includes at least one of a pattern identifier attribute, a pattern type attribute, an attribute indicating a device corresponding to a current pattern, an attribute indicating an avatar corresponding to the current pattern, an attribute indicating whether semantics of a haptics event corresponding to the current pattern exists, an attribute indicating a specification followed by the semantics of the haptics event, an attribute indicating whether the haptics event is classified into a layer, an attribute indicating a library haptics event included in the current pattern, and an attribute indicating a haptics channel included in the current pattern.

The haptics channel object includes at least one of a channel identifier attribute, a channel description attribute, an attribute indicating a device corresponding to a current channel, an attribute indicating an avatar corresponding to the current channel, a channel gain attribute, an attribute indicating whether the current channel is in an alternative relationship with another haptics channel, an attribute indicating an identifier of an alternative channel group to which the current channel belongs, an attribute indicating whether the current channel belongs to a particular channel group, an attribute indicating an identifier of a channel group to which the current channel belongs, an attribute indicating a weight of the current channel in a corresponding channel group, an attribute indicating whether a haptics event is classified into a layer, an attribute indicating a priority of the current channel, and an attribute indicating a haptics event included in a current channel.

When the alternative channel group to which the current channel belongs exists, in the attribute indicating the device corresponding to the current channel, the attribute indicating the avatar corresponding to the current channel, and the attribute indicating the priority of the current channel, only a haptics channel with a minimum identifier in the alternative channel group is indicated.

The haptics event object includes at least one of an event identifier attribute, an event semantics attribute, an event layer attribute, an event type attribute, an attribute indicating an identifier of a corresponding library haptics event when a type of an event is a reference event, an attribute indicating a time offset of a current event, an attribute indicating duration of the current event, an attribute indicating a signal maximum amplitude value of the current event, an attribute indicating a signal base frequency of the current event, and an attribute indicating a component forming the current event.

The component object includes at least one of an attribute indicating an identifier of a haptics event to which a current component belongs, an attribute indicating a time offset of the current component relative to the haptics event, an attribute indicating an amplitude value ratio of the current component to the haptics event, and an attribute indicating a frequency offset of the current component relative to the haptics event.

In addition, the haptics media binary bitstream mentioned in S230 includes a binary header and a binary load. In an example aspect, S230 includes the following operations.

S231: Perform, according to a predefined attribute conversion manner, binary bit format conversion on each attribute in each data object included in a haptics media interchange format, to obtain a binary bitstream segment corresponding to each data object.

S232: Form a binary header based on binary bitstream segments respectively corresponding to a haptics experience object, a haptics pattern object, and the haptics channel object, and form a binary load based on binary bitstream segments respectively corresponding to a haptics event object and a component object, to obtain a haptics media binary bitstream.

The predefined attribute conversion manner mentioned in S231 includes at least one of the following:
1) a string-type attribute, an integer-type attribute, an enumeration-type attribute, or a number-type attribute is converted into a binary bitstream segment of several integer bytes;
2) a Boolean-type attribute is converted into a binary bitstream segment of several bits;
3) a count of array elements included in an array-type attribute is statistically collected, and a corresponding attribute is converted into a binary bitstream segment based on the count of array elements;
4) when binary bit format conversion is performed on a haptics event object, a start code corresponding to the corresponding haptics event is added as a new attribute of the haptics event object, and conversion is performed to obtain a corresponding binary bitstream segment; and
5) when binary bit format conversion is performed on an event semantics attribute included in the haptics event object, if a specification followed by semantics of the corresponding haptics event is a current standard, semantic conversion is performed on the corresponding haptics event according to a semantic structure of a preset level, and a corresponding binary bitstream segment is obtained based on the converted semantics, the semantic structure of the preset level indicating that semantics of different levels is divided by using a specified symbol, or is converted into a specified binary field.

In addition, content recorded in any one of the foregoing items is described in the foregoing descriptions. Details are not described herein again.

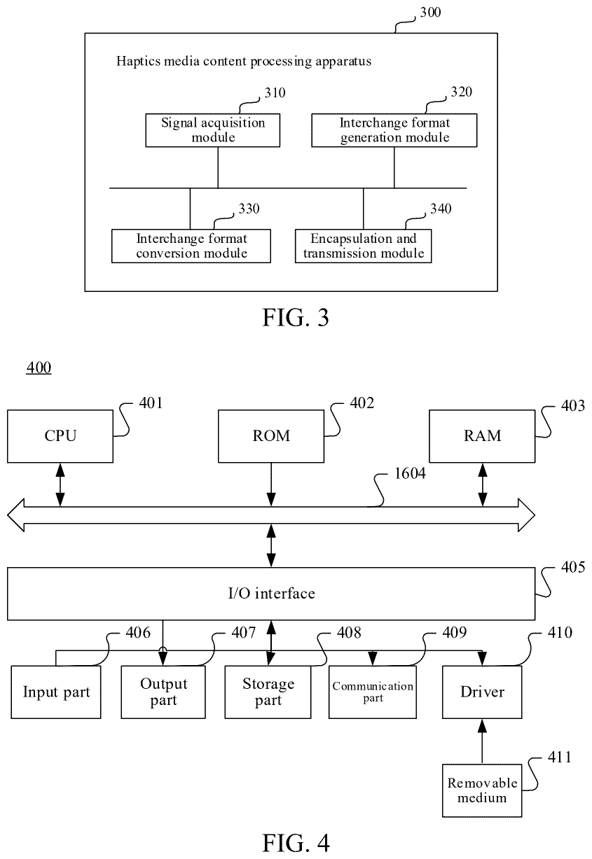

FIG. 3 is a block diagram of a haptics media content processing apparatus according to an example aspect of this disclosure. As shown in FIG. 3, an example haptic media content processing apparatus 300 includes:
a signal acquisition module 310, configured to acquire at least one haptics media signal;
an interchange format generation module 320, configured to generate a haptics media interchange format according to the at least one haptics media signal, the haptics media interchange format including at least one data object of a haptics experience object, an avatar information object, a device information object, a haptics pattern object, a haptics channel object, a haptics event object, and a component object;
an interchange format conversion module 330, configured to convert the haptics media interchange format, to obtain a haptics media binary bitstream;
an encapsulation and transmission module 340, configured to encapsulate the haptics media binary bitstream into a haptics media file, and transmit the haptics media file to a client.

In another example aspect, the haptics media binary bitstream includes a binary header and a binary load, and the interchange format conversion module 330 includes:
a conversion unit, configured to perform binary bit format conversion on each data object included in the haptics media interchange format based on a predefined attribute conversion manner; and
a bitstream acquisition unit, configured to take binary bit data that respectively corresponds to the haptics experience object, the haptics pattern object, and the haptics channel object and that is obtained through conversion as the binary header, and take binary bit data that corresponds to the haptics event object and the component object and that is obtained through conversion as the binary load, to obtain the haptics media binary bitstream.

In addition, the haptics media content processing apparatus provided in the aspects and the haptics media content processing method provided in the aspects belong to a same concept. Specific manners in which the modules and units perform operations have been described with respect to the method aspects. Details are not described herein again. In actual application, the functions of the haptics media content processing apparatus provided in the aspects may be allocated to and completed by different functional modules according to requirements. That is, an internal structure of the apparatus is divided into different functional modules to complete all or some of the functions described above. This is not limited herein.

The aspects of this disclosure further provide a haptics media content processing device, which includes: one or more processors; and a memory, configured to store one or more programs, the one or more processors executing the one or more programs, to cause the haptics media content processing device to implement the haptics media content processing method provided in the aspects.

FIG. 4 is a schematic structural diagram of a computer system adapted to implement a haptics media content processing device according to an aspect of this disclosure. In addition, a computer system 400 of the haptics media content processing device shown in FIG. 4 is merely an example, and does not constitute any limitation on functions and use ranges of the aspects of this disclosure.

As shown in FIG. 4, the computer system 400 includes processing circuitry, such as a central processing unit (CPU) 401, which may perform various suitable actions and processing based on a program stored in a read-only memory (ROM) 402 or a program loaded from a storage part 408 into a random-access memory (RAM) 403, for example, perform the method described in the aspects. The RAM 403 further has various programs and data required for system operations stored therein. The CPU 401, the ROM 402, and the RAM 403 are connected to each other through a bus 404. An input/output (I/O) interface 405 is also connected to the bus 404.

The following components are connected to the I/O interface 405: an input part 406 including a keyboard, a mouse, and the like; an output part 407 including a cathode ray tube (CRT), a liquid crystal display (LCD), a speaker, and the like; the storage part 408 including a hard disk, and the like; and a communication part 409 including a network interface card such as a local area network (LAN) card and a modem. The communication part 409 performs communication processing over a network such as the Internet. A driver 410 is also connected to the I/O interface 405 as required. A removable medium 411, such as a magnetic disk, an optical disk, a magneto-optical disk, or a semiconductor memory, is installed on the drive 410 as required, whereby a computer program read from the removable medium is installed into the storage part 408 as required.

Particularly, according to the aspects of this disclosure, the processes described above with reference to the flowcharts may be implemented as computer software programs. For example, the aspects of this disclosure include a computer program product, which includes a computer program stored in a computer-readable medium. The computer program includes a computer program configured for performing the method shown in the flowchart. In such an aspect, the computer program may be downloaded and installed from a network through the communication part 409, and/or installed from the removable medium 411. The CPU 401 executes the computer program, to implement various functions defined in the system of this disclosure.

In addition, the computer-readable medium shown in the aspects of this disclosure may be a computer-readable signal medium, a computer-readable storage medium, such as a non-transitory computer-readable storage medium, or any combination of the two. More specific examples of the computer-readable storage medium may include, but are not limited to, an electrical connection with one or more conductors, a portable computer disk, a hard disk, an RAM, an ROM, an erasable programmable ROM (EPROM), a flash memory, an optical fiber, a portable compact disc ROM (CD-ROM), an optical storage device, a magnetic storage device, or any appropriate combination thereof. The computer program included in the computer-readable medium may be transmitted by using any suitable medium, including but not limited to, a wireless medium, a wired medium, or any suitable combination thereof.

The flowcharts and block diagrams in the accompanying drawings illustrate possible system architectures, functions, and operations that may be implemented by the system, the method, and the computer program product provided in the aspects of this disclosure. Each box in the flowchart or the block diagram may represent a module, a program segment, or a part of code. The module, the program segment, or the part of code includes one or more executable instructions configured for implementing specified logic functions. In some alternative implementations, functions annotated in boxes may occur in order different from that annotated in the accompanying drawing. For example, two blocks shown in succession may actually be executed substantially in parallel, or they may sometimes be executed in the reverse order, depending on the functions involved. Each box in the block diagram or the flowchart and a combination of boxes in the block diagram or the flowchart may be implemented by using a dedicated hardware-based system configured for performing a specified function or operation, or may be implemented by using a combination of dedicated hardware and computer instructions.

The units involved in the aspects of this disclosure may be implemented by software or hardware, and the units described may be set in a processor. Names of the units do not constitute a limitation on the units in a specific case.

In another aspect, this disclosure further provides a computer-readable medium, which has a computer program stored therein. A processor executes the computer program, to implement the haptics media content processing method described above. The computer-readable storage medium may be included in the haptics media content processing device described in the aspects, or may exist independently without being assembled into the haptics media content processing device.

In another aspect, this disclosure provides a computer program product or a computer program, which includes computer instructions. The computer instructions are stored in a computer-readable storage medium. A processor of a computer device reads the computer instructions from the computer-readable storage medium, and executes the computer instructions, to cause the computer device to perform the haptics media content processing method provided in the aspects.

What is described above is merely example aspects of this disclosure, and is not intended to limit the implementations of this disclosure. Those of ordinary skill in the art may easily make corresponding changes or modifications according to the main concept and spirit of this disclosure. Therefore, the scope of this disclosure is subject to the claims.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

What is claimed is:

1. A haptic media content processing method, comprising:
obtaining at least one haptic media signal;
generating a haptic media interchange format based on the at least one haptic media signal, the haptic media interchange format including a haptic experience object, a haptic pattern object, a haptic channel object, a haptic event object, and a component element object;
converting the haptic media interchange format to obtain a haptic media binary bitstream;
encapsulating the haptic media binary bitstream into a haptic media file; and
transmitting the haptic media file to a client.

2. The method according to claim 1, wherein the haptic experience object comprises:
an attribute indicating a haptic pattern related to a current haptic experience, and
an attribute indicating whether a haptic event is classified into layers.

3. The method according to claim 1, wherein
the haptic media interchange format includes an avatar information object; and
the avatar information object comprises:
an attribute indicating an identifier of an avatar, and
an attribute indicating a type of an avatar model.

4. The method according to claim 1, wherein
the haptic media interchange format includes a device information object; and
the device information object includes at least one of:
an attribute indicating an avatar corresponding to a current device,
an attribute indicating specific information about the avatar corresponding to the current device, and
an attribute indicating a body part of the avatar corresponding to the current device.

5. The method according to claim 1, wherein the haptic pattern object is associated with a current haptic pattern and comprises:
an attribute indicating an identifier of a haptic pattern,
an attribute indicating a type of the of the haptic pattern,
an attribute indicating whether semantics of a haptic event corresponding to the current haptic pattern exists,
an attribute indicating a specification followed by the semantics of the haptic event when the semantics of the haptic event corresponding to the current haptic pattern exists, and
an attribute indicating a haptic channel included in the current haptic pattern.

6. The method according to claim 1, wherein
the haptic channel object comprises:
an attribute indicating an identifier of a current channel,
an attribute indicating a gain of the current channel,
an attribute indicating whether the current channel is in an alternative relationship with another haptic channel,
an attribute indicating an identifier of an alternative channel group to which the current channel belongs when the current channel is in the alternative relationship,
an attribute indicating whether the current channel belongs to a particular channel group,
an attribute indicating an identifier of the particular channel group to which the current channel belongs when the current channel belongs to the particular channel group,
an attribute indicating a weight of the current channel in the particular channel group when the current channel belongs to the particular channel group.

7. The method according to claim 1, wherein the haptic event object comprises:
an attribute indicating an identifier of a haptic event,
an attribute indicating semantics of the haptic event when the semantics of the haptic even corresponding to a current pattern exists,
an attribute indicating a layer of the haptic event when the haptic event corresponding to the current pattern is classified into the layer,
an attribute indicating a type of the haptic event,
an attribute indicating an identifier of a corresponding library haptic event when the type of the haptic event is a reference event,
an attribute indicating duration of the haptic event when the type of the haptic event is a continuous event,
an attribute indicating a signal maximum amplitude value of the haptic event, and an attribute indicating a signal base frequency of the haptic event.

8. The method according to claim 1, wherein the component element object includes an attribute indicating an identifier of a haptic event to which a current component element of the component element object belongs.

9. The method according to claim 1, wherein
the haptic media binary bitstream includes a binary header and a binary payload; and
the converting the haptic media interchange format comprises:
performing binary bit format conversion of the haptic media interchange format based on a predefined attribute conversion rule to obtain a binary bitstream segment corresponding to each of the haptic experience object, the haptic pattern object, the haptic channel object, the haptic event object, and the component element object;
forming the binary header of the haptic media binary bitstream based on binary bitstream segments corresponding to the haptic experience object, the haptic pattern object, and the haptic channel object; and
forming the binary payload of the haptic media binary bitstream based on binary bitstream segments corresponding to the haptic event object and the component object.

10. The method according to claim 9, wherein the predefined attribute conversion rule comprises at least one of:
converting a string-type attribute, an integer-type attribute, an enumeration-type attribute, or a number-type attribute into a binary bitstream segment having a predetermined number of bytes;
converting a Boolean-type attribute into a binary bitstream segment having a predetermined number of bits; and
determining a count of array elements in an array-type attribute and converting the array-type attribute into a binary bitstream segment based on the count of array elements.

11. The method according to claim 9, wherein the performing the binary bit format conversion comprises:
adding a start code corresponding to a haptic event as a new attribute of the haptic event object and converting the new attribute to obtain a first binary bitstream segment; and
when a specification followed by semantics of the haptic event includes a current standard, performing semantic conversion on the haptic event based on a semantic structure having a preset hierarchical level to obtain converted semantics, and obtaining a second binary bitstream segment based on the converted semantics, the semantic structure indicating that semantics of different hierarchical levels are divided using a specified symbol or converted into a specified binary field.

12. The method according to claim 1, wherein the transmitting comprises:
generating at least one file segment based on the haptic media file; and
transmitting the at least one file segment to the client.

13. A haptic media content decoding method, comprising:
receiving a haptic media file;
decapsulating the haptic media file to obtain a haptic media binary bitstream;
converting the haptic media binary bitstream to obtain a haptic media interchange format, the haptic media interchange format including a haptic experience object, a haptic pattern object, a haptic channel object, a haptic event object, and a component element object;
parsing the haptic media interchange format to obtain at least one haptic media signal; and
outputting the at least one haptic media signal to an output device.

14. The method according to claim 13, wherein the haptic experience object comprises:
an attribute indicating a haptic pattern related to a current haptic experience, and
an attribute indicating whether a haptic event is classified into layers.

15. The method according to claim 13, wherein
the haptic media interchange format includes an avatar information object; and
the avatar information object comprises:
an attribute indicating an identifier of an avatar, and
an attribute indicating a type of an avatar model.

16. The method according to claim 13, wherein
the haptic media interchange format includes a device information object; and
the device information object includes at least one of:
an attribute indicating an avatar corresponding to a current device,
an attribute indicating specific information about the avatar corresponding to the current device, and
an attribute indicating a body part of the avatar corresponding to the current device.

17. The method according to claim 13, wherein the haptic pattern object is associated with a current haptic pattern and comprises:
an attribute indicating an identifier of a haptic pattern,
an attribute indicating a type of the of the haptic pattern,
an attribute indicating whether semantics of a haptic event corresponding to the current haptic pattern exists,
an attribute indicating a specification followed by the semantics of the haptic event when the semantics of the haptic event corresponding to the current haptic pattern exists, and
an attribute indicating a haptic channel included in the current haptic pattern.

18. The method according to claim 13, wherein the haptic channel object comprises:
an attribute indicating an identifier of a current channel,
an attribute indicating a gain of the current channel,
an attribute indicating whether the current channel is in an alternative relationship with another haptic channel,
an attribute indicating an identifier of an alternative channel group to which the current channel belongs when the current channel is in the alternative relationship,
an attribute indicating whether the current channel belongs to a particular channel group,
an attribute indicating an identifier of the particular channel group to which the current channel belongs when the current channel belongs to the particular channel group,
an attribute indicating a weight of the current channel in the particular channel group when the current channel belongs to the particular channel group.

19. The method according to claim 13, wherein the haptic event object comprises:
an attribute indicating an identifier of a haptic event,
an attribute indicating semantics of the haptic event when the semantics of the haptic even corresponding to a current pattern exists,
an attribute indicating a layer of the haptic event when the haptic event corresponding to the current pattern is classified into the layer,
an attribute indicating a type of the haptic event,
an attribute indicating an identifier of a corresponding library haptic event when the type of the haptic event is a reference event,
an attribute indicating duration of the haptic event when the type of the haptic event is a continuous event,
an attribute indicating a signal maximum amplitude value of the haptic event, and
an attribute indicating a signal base frequency of the haptic event.

20. A haptic media content decoding apparatus, comprising
processing circuitry configured to:
receive a haptic media file;
decapsulate the haptic media file to obtain a haptic media binary bitstream;
convert the haptic media binary bitstream to obtain a haptic media interchange format, the haptic media interchange format including a haptic experience object, a haptic pattern object, a haptic channel object, a haptic event object, and a component element object;
parse the haptic media interchange format to obtain at least one haptic media signal; and
output the at least one haptic media signal to an output device.
